(19) United States
(12) Patent Application Publication
(10) Pub. No.: US 2025/0376380 A1
(43) Pub. Date: Dec. 11, 2025

(54) MULTI-STAGED PRODUCTION OF SILICON NANOPARTICLES

(71) Applicant: IONIC MINERAL TECHNOLOGIES, LLC, Provo, UT (US)

(72) Inventors: Maximilian Yan, Orem, UT (US); Jake E. Entwistle, Pleasant Grove, UT (US); Sun Ho Kang, San Jose, CA (US); Rajankumar L. Patel, Lehi, UT (US)

(73) Assignee: IONIC MINERAL TECHNOLOGIES, LLC, Provo, UT (US)

(21) Appl. No.: 19/231,260

(22) Filed: Jun. 6, 2025

Related U.S. Application Data
(60) Provisional application No. 63/656,784, filed on Jun. 6, 2024.

(51) Int. Cl. C01B 33/023

(52) U.S. Cl. CPC C01B 33/023

(57) ABSTRACT

A method of producing silicon particles includes providing a first mixture to an interior cavity of a rotary tube furnace. The first mixture includes a first amount of a silica precursor, a second amount of a thermal moderator, and a first fraction of a third amount of a metal reducing agent. The method includes performing a first thermal treatment to the first mixture. The method includes providing a second fraction of the third amount of the metal reducing agent to the treated first mixture to form a second mixture. The method includes performing a second thermal treatment to the second mixture. The method includes collecting a reaction product after performing the second thermal treatment. The reaction product includes the silicon particles. A mass ratio of the second amount to a sum of the first amount and the third amount is less than or equal to 1:1.

### CROSS-REFERENCE TO RELATED APPLICATIONS

This application claims the benefit of priority under 35 U.S.C. § 119(e) to U.S. Provisional Patent Application 63/656,784, titled “MULTI-STAGED PRODUCTION OF SILICON NANOPARTICLES,” filed Jun. 6, 2024, which is hereby incorporated herein by reference in its entirety.

### FIELD OF DISCLOSURE

The present disclosure is generally related to methods and apparatus of producing nanoparticles and specifically related to manufacturing porous silicon particles.

### BACKGROUND

Porous silicon particles (alternatively referred to as “porous silicon nanoparticles,” “porous silicon nanostructures,” or “porous silicon nanotubes,” or more generally as “silicon particles” or “silicon crystallites” in the following disclosure) are a promising anode material for lithium-ion batteries (LIBs) with a theoretical specific capacity of about 3600 milliampere-hours per gram mass (mAh/g), compared to the capacity of the conventional anode material graphite with a theoretical capacity of about 372 mAh/g. The significantly greater capacity of silicon may lead to higher energy density in LIBs. In addition, porous silicon particles have demonstrated other advantages including, for example, fast charging. Furthermore, porous silicon particles may also be utilized in other applications including, for example, hydrogen gas production, fuel cells, drug delivery, catalysis support, electronics, solar power, photoluminescence, photocatalysis, to name a few.

However, during battery operation the reversible lithiation of silicon causes porous silicon particles to undergo repeated volume expansion and contraction. In some instances, such volume expansion may be up to three-times the porous silicon particles' original volume. This is in contrast to an expansion of about 10% its original volume for graphite. The repeated volume expansion and contraction leads to degradation of the silicon material's structure during cycling and decline in its reversible capacity.

Existing implementations for mitigating porous silicon particles' degradation during lithiation in the LIB anode electrode include, for example, reducing the size of porous silicon particles to below a critical threshold and introducing pores in the porous silicon particles. At sizes less than the threshold (e.g., below about 150 nm), porous silicon particles generally do not pulverize upon expansion. Furthermore, a porous silicon particle may expand into its own pore volume, reducing the stress on the particle itself and any surrounding particles.

Current technologies of producing porous silicon particles suitable for LIB applications include, for example, top-down chemical vapor deposition (CVD) of silicon-containing gases (e.g., silane) onto carbon-based materials or other substrates (e.g., copper foil). However, the production of silane gas is currently lacking in scale, which also impacts the scalable production of porous silicon particles to significantly affect industries utilizing such porous silicon particles (e.g., the LIB anode industry). Additionally, the CVD method requires a substrate to fuse silicon into or onto, resulting in a lower capacity silicon composite versus an ability to produce a 100% silicon nano particle with the maximum theoretical capacity.

Other technologies for producing porous silicon particles include using a metallothermic reduction reaction in a top-down synthesis process. This method utilizes nanoscopic silica precursors and converts them into nanoscopic porous silicon particles in a reduction process. If done correctly, this reduction reaction takes place well below the melting point of both silicon and silica, therefore the nanoscopic structure can be maintained. Metallothermic reduction, however, is highly exothermic and therefore specific precautions are routinely taken to avoid a runaway reaction leading to potential destruction of nanoscopic structures and properties of the porous silicon particles. Many studies have implemented such reduction reaction in batch processes. However, such batch processes generally have three main drawbacks. Firstly, existing reaction vessels are generally designed to perform these reduction reactions at small scales (e.g., at a batch size of about 5 g), leading to a lower purity of the porous silicon particles, even though at small scales the overall exothermic energy can be kept low enough that it can be dissipated from the reaction vessels. Secondly, in a batch process, an upper reaction purity of silicon is usually determined by the reaction time, which ranges from one hour to ten hours, with six hours being the usual, lowering the efficiency of the production process. Thirdly, when the purity of the produced porous silicon particles is low, then hydrofluoric (HF) acid is required to remove any unreacted precursor materials (e.g., silica) from the porous silicon particles. Any one or more of these drawbacks can be a factor that can reduce the economic viability of the production of the porous silicon particles. Although scaling up the batch processes may address some aspects of these drawbacks, methods of dissipating the exothermic energy released during the metallothermic reduction reaction remains a challenge.

Accordingly, for at least these reasons, improvements in the scalable production of silicon, such as porous silicon particles, are desirable.

### SUMMARY OF DISCLOSURE

The present disclosure provides apparatus and methods of producing porous silicon particles.

In one aspect of the present disclosure, a method of producing silicon particles includes providing a first mixture to an interior cavity of a rotary tube furnace. The first mixture includes a first amount of a silica precursor, a second amount of a thermal moderator, and a first fraction of a third amount of a metal reducing agent. The method includes performing a first thermal treatment to the first mixture. The method includes providing a second fraction of the third amount of the metal reducing agent to the treated first mixture to form a second mixture. The method includes performing a second thermal treatment to the second mixture. The method includes collecting a reaction product after performing the second thermal treatment. The reaction product includes the silicon particles. A mass ratio of the second amount to a sum of the first amount and the third amount is less than or equal to 1:1.

In another aspect of the present disclosure, a method of producing silicon particles includes providing a first mixture to an interior cavity of a rotary tube furnace. The first mixture includes a silica precursor, a thermal moderator, and a first amount of a metal reducing agent. The method includes performing a first thermal treatment to the first mixture at a first temperature. The method includes providing a second amount of the metal reducing agent to the treated first mixture to form a second mixture. The method includes performing a second thermal treatment to the second mixture at a second temperature that is greater than or equal to the first temperature. The method includes collecting a reaction product after performing the second thermal treatment. The reaction product includes the silicon particles. An amount of the thermal moderator is less than or equal to a sum of an amount of the silica precursor, the first amount of the metal reducing agent, and the second amount of the metal reducing agent.

The methods of the present disclosure allow the metallothermic reduction of silica to be performed in a multistep (e.g., stepwise, staged), continuous process. The methods can include using an apparatus that includes, for example, a rotary furnace. The apparatus is configured to heat and mix reactants of the metallothermic reduction reaction while providing controlled temperature and atmospheric conditions. Advantageously, the production of porous silicon particles using the presently disclosed method has demonstrated higher throughput (e.g., the same or an increased amount of silicon particles generated over a shorter production period) than a one-step process, which is widely utilized in existing production of silicon particles.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIGS. 1 and 2 each illustrate a perspective view of an embodiment of an apparatus for manufacturing porous silicon particles, in accordance with some embodiments of the present disclosure.

FIG. 3 is a flow diagram illustrating a method of manufacturing porous silicon particles, in accordance with some embodiments of the present disclosure.

FIG. 4 is a plot illustrating a relationship between normalized daily throughput of a multistep metallothermic reduction reaction and a normalized ratio of an amount of a thermal moderator (e.g., salt) to an amount of reactants of the multistep metallothermic reduction reaction, in accordance with some embodiments of the present disclosure.

FIG. 5 is a plot comparing values of normalized throughput between multistep metallothermic reduction reactions implemented with different numbers of reaction steps and different amounts of a thermal moderator, in accordance with some embodiments of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

The metallothermic reduction of silica to produce porous silicon particles is generally highly exothermic, capable of rapidly releasing a large amount thermal energy (e.g., heat). In many instances, the metallothermic reduction reaction could set off a chain reaction, producing enough thermal energy (e.g., reaching over 1400° C.) to ignite reactants (e.g., the precursor silica and a metallic reducing agent) of the metallothermic reduction reaction. In this regard, if left uncontrolled, or substantially uncontrolled, such a metallothermic reduction reaction may result in a limited reaction throughput of the porous silicon particles as a reaction product.

One approach to mitigate such excess thermal energy and improve reaction throughput includes implementing the metallothermic reduction reaction in a continuous process in a rotary tube furnace, which has been described in detail in U.S. Publication No. 2024/0076192, the entire disclosure of which is incorporated herein by reference. An additional or alternative approach includes adding a thermal moderator, such as a salt, as a heat sink, for absorbing the excess thermal energy during the metallothermic reduction, thereby allowing the reaction to proceed without melting or igniting the reactants. Such thermal moderator generally has a melting point below that of silica/silicon and thus can absorb the excess thermal energy from the metallothermic reduction as latent thermal energy (e.g., melting energy) before melting, thereby protecting the reactants from structural damage. Example thermal moderator includes NaCl (having a melting point of about 800° C.), MgCl₂, or a combination thereof. Additionally or alternatively, other suitable salts capable of providing sufficient latent thermal energy (i.e., energy absorbed during its melting process) can also be used as thermal moderators in the present embodiments.

An amount of the thermal moderator in the metallothermic reduction reaction varies and may be defined as a ratio of the thermal moderator to the reactants (thermal moderator: reactants). Unless otherwise indicated in the present disclosure, the term “ratio” refers to a mass ratio. In existing implementations, the thermal moderator is generally applied in excess to the reactants such that the ratio of thermal moderator: reactants is generally greater than about 1:1 and can be up to about 4:1. Adding a thermal moderator is a known and effective method of reducing the thermal energy released during the metallothermic reduction and may be implemented in conjunction with the continuous process enabled by the rotary tube furnace. However, using a thermal moderator also introduces a number of challenges to the production of porous silicon particles.

Firstly, the thermal moderator can take up physical space in a reactor of the rotary tube furnace (or any other similar apparatus), leaving less room in the reactor for the reactants and therefore a reduced reaction throughput. For example, with a thermal moderator: reactants ratio of about 4:1, an example composition of the reactants includes about 10 wt % magnesium (Mg; an example metal reducing agent), about 10 wt % silica (an example precursor), and about 80 wt % sodium chloride (NaCl; an example thermal moderator). If the metallothermic reduction reaction proceeds to its full extent, then the silica loses about 50% of its weight to produce the reaction product (i.e., the porous silicon particles). Accordingly, the amount of the porous silicon particles (Si) in the overall product mixture, which includes the porous silicon particles and magnesium oxide (MgO), for example, is only about 5 wt %, while the amount of NaCl remains at about 80 wt %. Furthermore, cost of production would increase due to the need to handle such a large amount of NaCl using additional pre-and post-processing ancillary equipment.

Secondly, it is difficult to physically separate NaCl from the remainder of the product mixture (e.g., the porous silicon particles) after the metallothermic reduction reaction is completed as NaCl is generally a powdered material and has particle sizes similar to those of the porous silicon particles. As a result, NaCl is generally removed via a solution-based washing process. MgO is typically removed using hydrochloric acid, and additional water must be used to dilute this acid such that all the NaCl can be dissolved and removed from the porous silicon particles. In many instances, NaCl and MgO are not effectively removed in a single washing step and often require multiple washing steps to achieve a suitable level of product purity. This process vastly increases the amount of washing water required in the industrial washing process. It is noted that such an issue is generally not apparent in small-or bench-scaled production, but becomes much more pronounced when the production is scaled to a level of about 2,000 metric ton per annum (MT/y to about 20,000 MT/y, as is the level implemented in the rotary tube furnace, and this amount of washing water becomes economically costly and physically difficult.

Thirdly, the removal of MgO from porous silicon particles using HCl can also pose a challenge. For example, the products of this removal process include magnesium chloride (MgCl₂) and water (H₂O) in solution form (e.g., a brine solution). While MgCl₂ has significantly more economic value than NaCl, it is often difficult to separate the two salts as they are both dissolved in a brine solution. Furthermore, a byproduct that contains a mixture of both salts is also less valuable than a pure byproduct of either. Accordingly, reducing an amount of NaCl as the thermal moderator can improve the isolation of MgCl₂ from the brine solution and therefore increase the economic value recovered from the secondary products and/or byproducts of the metallothermic reduction reaction.

The present disclosure provides methods related to implementing a multistep (i.e., including two or more steps) metallothermic reduction reaction (hereafter referred to as the “multistep reaction”) for producing silicon particles (e.g., porous silicon particles). In some embodiments, the methods provided herein are implemented using a significantly less amount of a thermal moderator in comparison to existing methods of producing the silicon particles in a one-step (e.g., single-step) metallothermic reduction reaction, thereby improving the throughput of the silicon particles. In some embodiments, the multistep reaction provided herein obviates or at least reduces the need for any thermal moderator.

During the multistep reaction, a fraction of an amount of a metal reducing agent (e.g., Mg) is added to a mixture of a silica precursor and optionally a thermal moderator (e.g., NaCl) at each step, such that the thermal energy released during each step of the multistep reaction is reduced and a lesser amount of a thermal moderator is thus required. As the exothermic energy (e.g., thermal energy) released at each step is lower due to the presence of a lower amount of the metal reducing agent compared to a one-step reaction, the amount of the thermal moderator needed to control the exothermic energy can be significantly reduced. In some instances, such a reduction in the amount of the thermal moderator can be so significant that it can offset the cost of having to perform the reaction twice (or multiple times).

The multistep reaction of the present disclosure is not limited by a number of steps implemented to complete the reaction. For example, the multistep reaction may include two steps, three steps, four steps, and so on. In this regard, the fraction of the metal reducing agent added at each step may be adjusted according to a total amount of the metal reducing agent needed and the number of steps to be performed. For example, for a two-step metallothermic reduction reaction (hereafter referred to as the “two-step reaction”), about 50% portion of the metal reducing agent may be added at the first step and a balance (i.e., about 50%) of the metal reducing agent is subsequently added at the second step of the two-step reaction.

In many embodiments, a thermal moderator: reactants ratio of the multistep reaction, defined as a ratio of a total amount of the thermal moderator to a sum of a total amount of the silica precursor and a total amount of the metal reducing agent, is from 0 to about 1:1. In one such example, the thermal moderator: reactants ratio may be less than about 4:5. A thermal moderator: reactants ratio of 0 indicates that no salt is added during the multistep reaction, which may significantly improve a throughput of the multistep reaction. In comparison to existing technologies, which may require a thermal moderator: reactants ratio of up to about 5:1 in a one-step metallothermic reduction reaction, the thermal moderator: reactants ratio of the multistep reaction may be reduced by about 75% in some embodiments.

Embodiments of the multistep reaction described herein provide at least the following advantages. Firstly, reducing the amount of thermal moderator needed during the multistep reaction increases the total amounts of the reactants, i.e., the silica precursor and the metal reducing agent, that can be processed in a reactor (e.g., a rotary tube furnace), leading to an increased throughput of a final product (e.g., porous silicon particles). Secondly, such an increase in the throughput does not adversely affect quality of the final product. In fact, the quality may be improved due to improved control of the exothermic energy (e.g., thermal energy) released during the multi-step reaction. Thirdly, the overall cost of production can be reduced as less thermal moderator (e.g., salt) is used per unit weight of the reaction product. Fourthly, the amount of washing water needed for removing the thermal moderator is reduced, which not only further lowers the cost of production but also allows for more reaction product to be made with limited water supply. Fifthly, waste effluent streams (as byproduct(s) of the multistep reaction) that that need to be processed, recycled, and/or discharged are also reduced. Sixthly, embedded CO₂ emissions and embedded energy cost associated with the reaction product is lowered, reducing the cost of production and consequently the cost of sales as a benefit for the consumers.

In many embodiments, the multistep reaction is compatible with applications at industrial production scale (e.g., >10,000s MT/y), which is accomplished by implementing a continuous process in a rotary tube furnace. In some embodiments, the continuous process includes applying one or more of continuous agitation, gas flow rate control, and feed rate control to control (e.g., maintain, reduce, etc.) the exothermic energy of the metallothermic reduction reaction. Details of an example rotary tube furnace and a method of operating the same are described below.

### I. Overview of An Example Rotary Tube Furnace

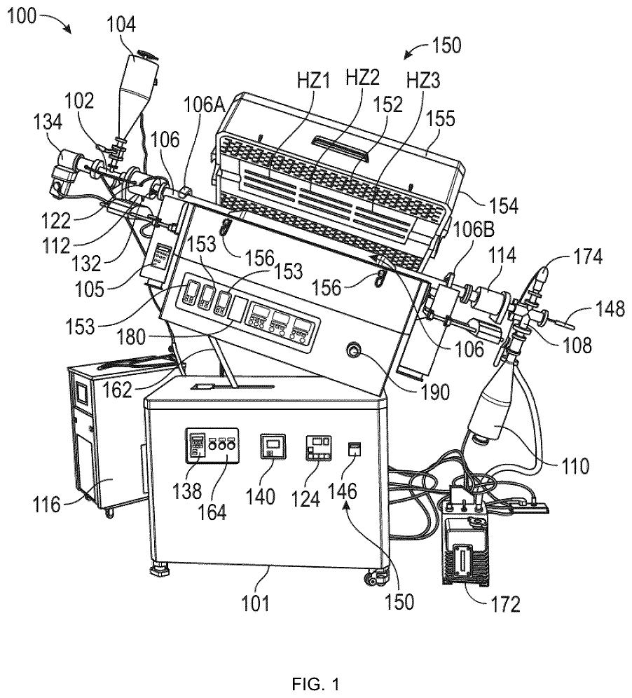

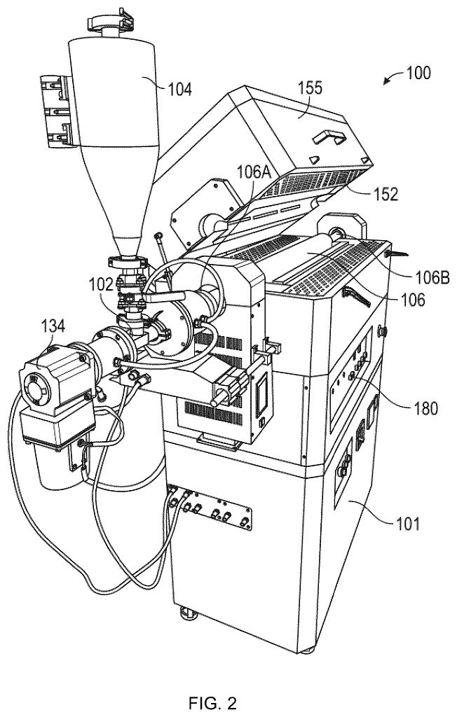

Referring to FIGS. 1 and 2, an example rotary tube furnace 100 (hereafter referred to as “furnace” for simplicity) is provided. The furnace 100 is configured to manufacture or otherwise produce nanoparticles. Particularly, the furnace 100 is designed to house a metallothermic reduction reaction (alternatively referred to as a “metallothermic reaction,” an “exothermic reaction,” or a “reduction reaction” in the following disclosure) between a silica precursor and a metal reducing agent (alternatively referred to as “metal reductant” or “metal reactant” in the following disclosure) for producing porous silicon particles. It is noted that FIGS. 1 and 2 collectively depict a non-limiting example embodiment of the furnace 100 from various perspectives. For example, FIG. 1 shows an overview of a frontside of the furnace 100, while FIG. 2 shows the furnace 100 from a perspective sideview. Components of the furnace 100 depicted herein may be omitted or replaced, and additional components may be introduced in accordance with embodiments of the present disclosure.

In the present embodiments, the furnace 100 includes a pedestal 101 to structurally support various components of the furnace 100. The furnace 100 includes a material inlet 102 connected (or coupled) to a tube 106 at a first opening 106A, which is connected to a material outlet 108 at a second opening 106B opposite the first opening 106A. The furnace 100 may further include a reactant feed hopper 104 coupled to the material inlet 102, such that reactants of a reaction stored in the reactant feed hopper 104 may be provided to the tube 106 through the material inlet 102. The furnace 100 may further include a product hopper 110 configured to store products (and byproducts) once the reaction is completed. As will be discussed in detail below, the pedestal 101 is configured to tilt to increase a rate at which the reactants are moved through the tube 106 from the material inlet 102 toward the material outlet 108.

In an example embodiment, the reactants stored in the reactant feed hopper 104 include the silica precursor and/or the metal reducing agent for the metallothermic reaction to produce the porous silicon particles, which may be the product stored in the product hopper 110. In some instances, a reaction byproduct, such as a metal oxide of the metallothermic reaction, may also be stored in the product hopper 110 before being removed. For embodiments in which the reactants are in solid phase, the reactants may be loaded in the reactant feed hopper 104 and fed through the material inlet 102. In some embodiments, one or more thermal moderators, such as magnesium chloride (MgCl₂), sodium chloride (NaCl), and/or other suitable salts, are fed through the material inlet 102 before, during, or after feeding the reactants. The thermal moderator is configured to control an amount of exothermic energy (e.g., thermal energy) released during the metallothermic reaction by absorbing the exothermic energy before melting occurs. In some embodiments, the thermal moderator(s) are first dried in an oven at about 110° C. before being fed through the material inlet 102. In some embodiments, the silica precursor, the metal reducing agent, and the thermal moderator are mixed and stored in the reactant feed hopper 104 before being fed through the material inlet 102 and into the tube 106.

In some embodiments, the furnace 100 further includes a feeding speed control 105 coupled to the material inlet 102. In some examples, the feeding speed control 105 is disposed between the material inlet 102 and the first opening 106A of the tube. The feeding speed control 105 is configured to adjust a rate at which the reactants in the reactant feed hopper 104 are fed into the tube 106 through the material inlet 102.

The tube 106 includes an annular wall surrounding an interior cavity, which is configured to contain the reactants received through the material inlet 102. In some embodiments, the tube 106 extends continuously between the first opening 106A and the second opening 106B along a longitudinal axis AA′. In some embodiments, an interface between the material inlet 102 and the first opening 106A of the tube 106 is separated by a magnetic fluid sealing element 112, and an interface between the material outlet 108 and the second opening 106B of the tube 106 is separated by a magnetic fluid sealing element 114, which may be similar to the magnetic fluid scaling clement 112. The magnetic fluid sealing elements 112 and 114 are configured to seal the interior cavity of the tube 106, which may be maintained at an elevated temperature and/or reduced pressure, from a surrounding environment. In some embodiments, the furnace 100 further includes a chiller 116 coupled to the magnetic fluid sealing elements 112 and 114, the chiller 116 being configured to provide cooling fluid to keep the magnetic fluid sealing elements 112 and 114 below 25° C. to reduce or prevent thermal damage. The chiller 116 provides cooling by circulating water at about 21° C. continuously through the magnetic fluid sealing elements 112 and 114.

In the present embodiments, still referring to FIGS. 1 and 2, the furnace 100 includes a gas module 120 configured to provide a gas (e.g., an inert gas such as argon (Ar), nitrogen (N₂), other suitable gases, or combinations thereof) to the interior cavity of the tube 106 and subsequently monitor the pressure and gas flow rate within the interior cavity. In this regard, the gas module includes at least a gas inlet 122 coupled to the material inlet 102 in fluid connection. In the present disclosure, “fluid connection” may refer to a physical, point-to-point connection between two components. Alternatively, “fluid connection” may refer to two components being connected though a third component (e.g., a segment of a tubing), such that a fluid (e.g., gas or liquid) may be transferred between the two components. The present disclosure does not limit the specific location of the gas inlet 122 so long as it is located between the material inlet 102 and the first opening 106A of the tube 106. The gas module 120 further includes a pressure gauge 124 coupled to the interior cavity of the tube 106 and configured to measure pressure exerted by the gas. In some examples, the pressure gauge 124 may be a Pirani gauge; though other types of pressure-measuring devices may also be applicable. The gas module 120 may further include one or more transmission lines (e.g., tubes; not depicted) coupling the gas inlet 122 to a gas tank (not depicted) as well to a digital gas flow meter (not depicted). In an example embodiment, one or more reactant in gas phase may be fed from a gas tank through the gas inlet 122 and into the interior cavity of the tube 106.

In the present embodiments, the furnace 100 includes a mixing module 130 configured to continuously rotate the tube about the longitudinal axis AA′, thereby simultaneously other otherwise concurrently mixing and pushing forward the reactants along a length of the tube 106 between the first opening 106A and the second opening 106B. In some embodiments, the mixing module 130 includes: a screw feeder 132 partially extending into the interior cavity of the tube 106; a motor and bearings 134 coupled to an end of the screw feeder 132 and/or to a segment of the tube 106 and configured to rotate the screw feeder 132 and/or the tube 106; a rotation speed control 138 coupled to the motor and configured to monitor the rotation speed of the motor and bearings 134; and a mass flow readout device 140 coupled to the tube 106 and configured to display calculated (or estimated) mass flow data of the reactant as it travels through the tube 106. In some embodiments, the screw feeder 132 is configured to spiral forward (i.e., rotated) toward the material outlet 108 to transport the reactants from the material inlet 102 into the tube 106. In some examples, the screw feeder 132 may be an auger screw. In some embodiments, the mixing module 130 further includes a chiller 142 coupled to the motor and bearings 134 and configured to provide cooling against overheating.

In the present embodiments, the furnace 100 includes a heating module 150 coupled to the tube 106. In some embodiments, the heating module 150 includes one or more heating elements 152 configured to surround the tube 106 so as to provide heating from various positions around the tube 106. The heating elements 152 may emit heat by any suitable method, such as by resistive heating, conduction heating, IR heating, combustion heating, other heating methods, or combinations thereof. The heating module 150 further includes a temperature gauge 146 coupled to the tube 106 and configured to monitor a temperature within or near the tube 106. The temperature gauge 146 may be any suitable device, such as a K-type thermocouple. In some embodiments, the heating elements 152 are configured to heat the tube 106 to a selected temperature (or several temperatures over a range of temperatures), which can be monitored using the temperature gauge 146.

In some embodiments, as depicted in FIG. 1, the heating elements 152 include a first heating zone HZ1, a second heating zone HZ2, and a third heating zone HZ3, arranged in this order along a length of the tube 106 between the first opening 106A and the second opening 106B. The heating zones HZ1-HZ3 may be programmed independently by a controller 153, which may be coupled to a control panel 180 (described in detail below), to provide different thermal treatments to different portions of the interior cavity of the tube 106. In some embodiments, the heating zones HZ1-HZ3 correspond to portions of the interior cavity of the tube 106 with different temperatures. For example, a first portion of the tube 106 corresponding to the first heating zone HZ1 has a first temperature T1, a second portion of the tube 106 corresponding to the second heating zone HZ2 has a second temperature T2, and a third portion of the tube 106 corresponding to the third heating zone HZ3 has a third temperature T3, where T1≤T2≤T3. In some embodiments, the temperatures T1-T3 are programmed according to the different thermal treatments applied to a mixture of the reactants of the reduction reaction. In this regard, the mixture of reactants can be continuously mobilized through different portions of the tube 106 to receive different thermal treatments without repeatedly adjusting (e.g., repeated temperature ramping and cooling) the heating elements 152 and/or halting the production process. As a result, the overall throughput of the production process may be improved. In some embodiments, the heating zones HZ1-HZ3 are programmed to the same temperature in the interior cavity of the tube 106.

The furnace 100 may further include a slide sealing element 148 configured to seal the temperature gauge 146 (e.g., a thermocouple) in place, allowing the temperature gauge 146 to measure the temperature within the interior cavity of the tube 106 in-situ during the reduction reaction.

In the present embodiments, the furnace 100 further includes an insulating chamber 154 encasing the heating elements 152 and the tube 106, where the insulating chamber 154 is configured to isolate the tube 106 held at the selected temperature from the temperature in the surrounding environment (e.g., outside the insulating chamber 154). In some embodiments, the insulating chamber 154 includes a chamber door 155 that can be fastened to a body of the insulating chamber 154 by one or more locks 156. Such locks may provide improved scaling of the chamber door 155 for enhanced insulation.

In the present embodiments, the furnace 100 includes a tilting module 160 that includes a tilting element 162 attaching the body of the insulating chamber 154 to the pedestal 101 and a tilting control 164 coupled to the tilting clement 162. The tilting element 162 is configured to extend and retract in response to an instruction received from the tilting control 164 and determined by a user. The tilting element 162 may be driven by an actuator or other suitable mechanical means. In the present embodiments, the body of the insulating chamber 154 is coupled to the pedestal 101 to allow the insulating chamber 154 be tilted as shown. For example, attachment points between the pedestal 101 and the body of the insulating chamber 154 serve as pivotal points about which the insulating chamber 154 is tilted. By extending the tilting element 162, a first end of the tube 106 coupled to the material inlet 102 is raised or elevated relative to a second end of the tube 106 coupled to the material outlet 108, causing material(s) in the interior cavity of the tube 106 to be moved toward the material outlet 108. This, coupled with the motor-driven rotation of the tube 106, contributes to a lowered residence time of reactants within the tube 106 and encourages higher throughput for the overall reaction. FIG. 1 depicts the furnace 100 with the tilting element 162 extended and FIG. 2 depicts the furnace 100 with the tilting element 162 retracted.

In the present embodiments, the furnace 100 further includes a vacuum module 170 having a vacuum pump 172 coupled to the tube 106 and a vacuum gauge 174 configured to measure a level of vacuum (i.e., pressure) in the interior space of the tube 106. The vacuum pump 172 may be any suitable pump, such as a mechanical pump or a diffusion pump, in fluid connection with the tube 106. In some examples, the vacuum gauge 174 may be disposed over the material outlet 108 as shown.

Furthermore, as shown in FIGS. 1 and 2, the furnace 100 may include a control panel 180 configured to receive instructions from a user and implement the received instructions by controlling one or more of the mixing module 130, the heating module 150, the tilting module 160, and the vacuum module 170. The furnace 100 may further include a display module (not depicted) coupled to the control panel 180 and configured output operation data related to one or more of the mixing module 130, the heating module 150, the tilting module 160, and the vacuum module 170. In some embodiments, each of the feeding speed control 105 and the rotation speed control 138 may include a control module and a display module for adjusting and monitoring their respective operations. Still further, the furnace 100 may include an emergency stop 190 that is configured to halt the operation of the furnace 100 when switched to an “on” position.

In some embodiments, the furnace 100 may be powered electrically, by combustion, by microwave, or other suitable source(s).

The furnace 100 can be configured to implement a multistep reaction in the continuous process, according to some embodiments of the present disclosure, to reduce (or eliminate) the amount of the thermal moderator needed during the metallothermic reduction, thereby further improving the throughput of the production of the porous silicon particles. In many embodiments, the furnace 100 and the method of operating the same allow the multistep reaction to be implemented at industrial production scale (e.g., >10,000 s MT/y) as described above.

### II. Overview of An Example Multistep Metallothermic Reduction Reaction

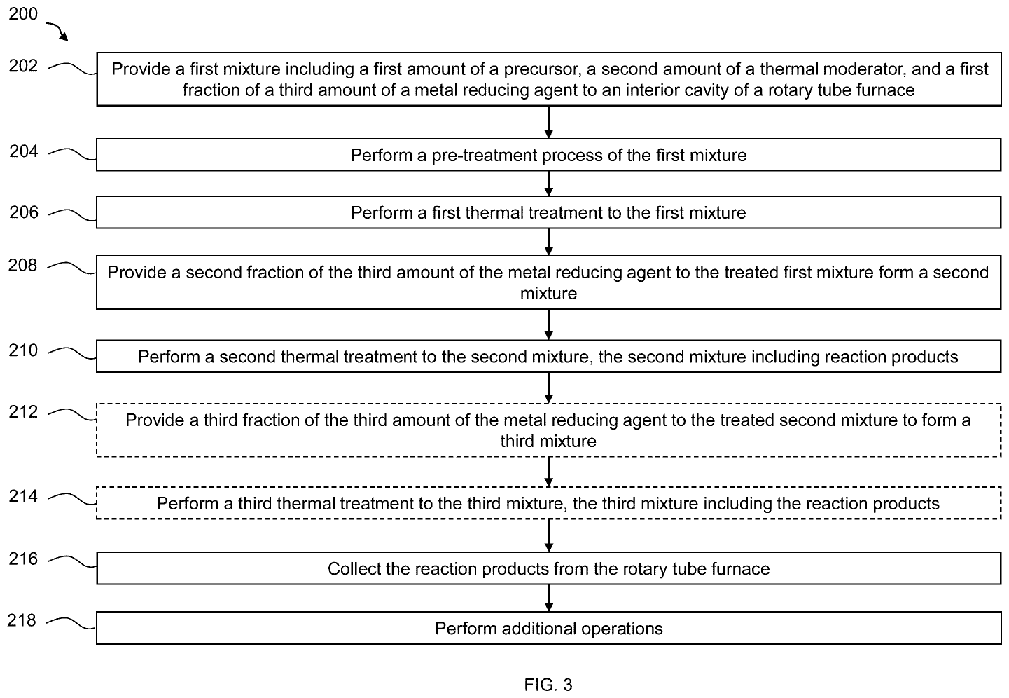

FIG. 3 is a flow diagram depicting an embodiment of a method 200 of producing porous silicon particles, according to some embodiments of the present disclosure. The method 200 may, in some embodiments, be performed in/by or otherwise using an embodiment of the furnace 100 discussed in detail above. The method 200 may also be performed with other embodiments of furnaces. The method 200 is merely an example, and is not intended to limit the present disclosure. Accordingly, it should be understood that additional operations may be provided before, during, and after the method 200 of FIG. 3.

At operation 202, the method 200 provides (or receives) a first mixture into the interior cavity of a rotary tube furnace, an example of which is depicted as the furnace 100 in FIGS. 1 and 2 and discussed in detail above. In this regard, the first mixture is provided (e.g., fed into) to the tube 106 through the material inlet 102.

The first mixture includes a silica (SiO₂) precursor, a metal reducing agent (e.g., Mg), and a thermal moderator. The first mixture may first be stored in the reactant feed hopper 104 and fed through the material inlet 102 at a rate controlled by the feeding speed control 105. In some embodiments, the reactant feed hopper 104 may be evacuated, e.g., through its top opening, using a vacuum pump, and may also be heated with a jacket to completely degas and remove any residual water from the first mixture before passing into the tube 106. In the present embodiments, the silica precursor and the metal reducing agent are mixed and subsequently processed in the furnace 100 to form porous silicon particles.

In the present embodiments, the method 200 is implemented as a multistep (e.g., two-step, three-step, etc.) metallothermic reaction described above. In this regard, a portion, rather than an entirety, of a component (e.g., the metal reducing agent) of the reactants is provided at each step of the multistep reaction, which can be described by Equation I below. In other words, the multistep reaction includes a series of steps each consuming a portion of the component of the reactants and producing a portion of the reaction product as a result. In a one-step reaction, however, an entire amount of each of the silica precursor and the metal reducing agent, along with the thermal moderator, are provided as a mixture before initiating the metallothermic reaction.

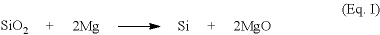

In a multistep reaction such as that embodied in the method 200, a total amount of metal reducing agent is divided into fractions, where one fraction of the total amount is added at each step of the multistep reaction. For example, at operation 202, the first mixture includes a first amount (i.e., a total amount in moles) of the silica precursor, a first fraction of a second amount (i.e., a total amount in moles) of the thermal moderator, where the first fraction of the second amount is greater than or equal to 0 and less than or equal to 1, and a first fraction (e.g., first portion, first part, etc.) of a third amount (i.e., a total amount in moles) of the metal reducing agent, where the first fraction of the third amount is greater than 0 and less than 1.

After performing a first step (e.g., a first thermal treatment) of the multistep reaction in the furnace 100 during which the first fraction of the metal reducing agent is reacted (e.g., consumed), a second fraction of the thermal moderator and a second fraction of the metal reducing agent are added to the now-treated (or reacted) first mixture, and a second step (e.g., a second thermal treatment) of the multistep reaction is performed in the furnace 100. Depending on the value of the first fraction of the thermal moderator used at the first step, the second fraction of the thermal moderator may be greater than or equal to 0 and less than or equal to 1. The treated first mixture includes any unreacted silica precursor, which is less than the first amount in quantity, all (or substantially all) of the first fraction of the thermal moderator, and reaction products that include silicon particles (e.g., porous silicon particles) and MgO. The treated first mixture is free, or substantially free, of any metal reducing agent, which has been consumed during the first step, and an amount of the reaction products corresponds to the first fraction of the metal reducing agent included in the first mixture before performing the first step.

If the multistep reaction includes only two steps, then a sum of the first fraction of the metal reducing agent and the second fraction of the metal reducing agent is equal to 1, and a sum of the first fraction of the thermal moderator and the second fraction of the thermal moderator is equal to 1. If one or more additional steps are performed after performing the second step, then the sum of the first fraction of the metal reducing agent and the second fraction of the metal reducing agent is less than 1, and the sum of the first fraction of the thermal moderator and the second fraction of the thermal moderator is less than 1.

In some embodiments, the first fraction of the second amount and the second fraction of the second amount are each greater than 0 and less than 1, such that their sum is 1. In some embodiments, the first fraction of the second amount is 0 and the second fraction of the second amount is 1, such that their sum is 1. In some embodiments, the first fraction of the second amount is 1 and the second fraction of the second amount is 0. In other words, an entirety of the second amount of the thermal moderator is included in the first mixture before performing the first step, and no additional amount of the thermal moderator is added before performing the second step. In such an example, the total amount of the silica precursor (i.e., the first amount) and the total amount (i.e., the second amount) of the thermal moderator are determined at the first step and may not change, or substantially change, throughout the subsequent steps of the multistep reactions.

In some embodiments, the first step of the multistep reaction includes performing a first thermal treatment (e.g., at operation 206 of the method 200) to heat the first mixture, during which a portion of the silica precursor would react with the first fraction of the metal reducing agent to produce the reaction products that include the porous silicon particles and a metal oxide (e.g., MgO according to Equation I). Subsequently, the second fraction of the metal reducing agent is added to the reaction product of the first step and the unreacted portions of the first mixture to form a second mixture at the second step of the multistep reaction (e.g., at operation 208). The second step further includes performing a second thermal treatment to the second mixture (e.g., at operation 210), causing the second fraction of the metal reducing agent to react with the unreacted silica precursor in the second mixture and produce additional reactant products.

For embodiments in which the multistep reaction is a two-step reaction, a sum of the first fraction of the metal reducing agent and the second fraction of the metal reducing agent is equal to 1. In one example, the first fraction of the metal reducing agent may range from about 10% to about 60%, inclusive, and the second fraction of the metal reducing agent may range from about 40% to about 90%, inclusive. In the case of the thermal moderator, the first fraction may be as low as 0 but as high as 1. The sum of the first fraction of the thermal moderator and the second fraction of the thermal moderator is equal to 1

For embodiments in which the multistep reaction is a three-step reaction, a third fraction of the metal reducing agent is added after performing the second thermal treatment, and a third thermal treatment is subsequently performed. In this regard, a sum of the first fraction of the metal reducing agent, the second fraction of the metal reducing agent, and the third fraction of the metal reducing agent is equal to 1. Similarly, a sum of the first fraction of the thermal moderator, the second fraction of the thermal moderator, and the third fraction of the thermal moderator is also equal to 1.

In some embodiments, a ratio of the first amount to the third amount is about 1:1, i.e., the first mixture includes equal parts of the silica precursor and the metal reducing agent. In some embodiments, the ratio of the first amount to the third amount is in a range of about 1:1 to about 1:1.1. In some instances, a 10% surplus of the metal reducing agent (e.g., Mg) can be beneficial. Stated differently, the first amount may range from about 1.0 time to about 1.1 times the third amount (on a mass basis). The benefit of having the 10% surplus of the metal reducing agent (i.e., a mass ratio of 1:1.1 of the silica precursor to the metal reducing agent) is to drive the reduction reaction to completion. Providing a slight excess (e.g., about 10% by mass ratio) of the metal reducing agent may help to consume all the silica precursor and yield a purer silicon product. By ensuring that all silica is consumed, the process may inherently yield a purer silicon product (i.e., silicon nanoparticles). A purer silicon product is generally more desirable for various applications, especially in high-performance materials such as those used in lithium-ion batteries. This improves the process efficiency that is crucial for production of silicon nanoparticles at a commercial scale. In some embodiments, a ratio of the second amount to the sum of the first amount and the third amount is less than or equal to about 1:1, i.e., the second amount does not exceed the sum of the first amount and the third amount.

In a two-step reaction, for example, a ratio of the amount of the silica precursor: the amount of the metal reducing agent: the amount of the thermal moderator (e.g., the first amount: the first fraction of the third amount: the second amount) in the first mixture before performing the first step may be about 2:1:4 and such ratio is increased to about 2:2:4, or 1:1:2, after adding the second fraction of the metal reducing agent. In this regard, the ratio of the amount of the thermal moderator (i.e., the second amount) to the sum of the amounts of the reactants (i.e., the sum of the first amount and the third amount) is about 1:1.

In some embodiments, by increasing the number of steps while holding the total amount of the metal reducing agent (i.e., the third amount) constant, the amount of the metal reducing agent introduced at each step can be reduced and the amount of the thermal moderator used (i.e., the second amount) can be reduced accordingly. In this regard, the ratio of the amount of the thermal moderator to the sum of the amounts of the reactants can be reduced to less than or equal to about 1:1. In one example, the thermal moderator: reactants ratio may be reduced to less than about 4:5. In another example, the thermal moderator can be entirely omitted, such that the ratio of the thermal moderator to the sum of the amounts of the reactants may be reduced to 0. In other words, the need for using the thermal moderator to absorb excess exothermic energy released during each step of the multistep reaction is obviated. Accordingly, implementing the multistep reaction provided herein can reduce the ratio of the thermal moderator to the sum of the amounts of the reactants to a range of from 0 to about 1:1.

In some embodiments, the silica precursor may be obtained from a halloysite, which is a naturally occurring aluminosilicate with the chemical formula Si₂Al₂O₅(OH)₄. The halloysite may include aluminosilicate in a nanotube structure. The silica precursor may be obtained from the halloysite through a series of operations of a purification process. In the present embodiments, a sample of halloysite feedstock is dehydrated, removing any structural water, and dealuminated, removing alumina (Al₂O₃), to produce a pure, or substantially pure, sample of silica nanotubes. In some examples, the dealuminated halloysite may subsequently be dried in an oven at about 110° C. The halloysite feedstock from which the silica precursor is derived may be in the form of small-sized pieces obtained directly from a halloysite mining location. Silica precursor derived from other sources, naturally occurring or synthetic, may also be applicable in the present embodiments. In some instances, the removed alumina may be captured and resold as a critical mineral for a variety of applications. In some examples, the halloysite feedstock may include about 50 wt % of AlO₃and about 50 wt % of SiO₂, and after performing the dealumination, the amount of Al₂O₃ may be reduced to less than about 50 wt %. In further examples, the amount of Al₂O₃ may be reduced to about 5 wt % to about 15%, such as about 10 wt %.

Advantageously, the silica nanotubes obtained from halloysite are generally porous and such porous structure may be maintained during the subsequent metallothermic reaction, producing porous silicon particles suitable for various applications. In some embodiments, the dealumination process is carried out to varying degrees, such that the portion of the alumina remaining in the silica precursor may be controlled. In other words, the silica precursor obtained from halloysite may also include aluminum in the form of alumina.

In some embodiments, the silica precursor obtained from the halloysite is spray-dried to increase its bulk density, which in turn increases the throughput and efficiency of the subsequent metallothermic reaction in the furnace 100. In some embodiments, the silica precursor derived from halloysite has a particle size ranging from about 50 nm in diameter and about 500 nm to about 1 μm in length (e.g., less than about 400 mesh in particle size) to about 6 mm (e.g., about 3 mesh in particle size). In some embodiments, the silica precursor has a particle size ranging from 10 nm to about 44 μm (e.g., about 325 mesh). In some embodiments, the particle size of the silica precursor is generally maintained in, or at least correlated with, the resulting porous silicon particles. In this regard, the particle size of the porous silicon particles can be controlled by adjusting the particle size and shape of the silica precursor. A specific particle size of the silica precursor may be controlled during the dehydration (e.g., spray-drying) and/or the dealumination processes to improve throughput. The drying of the dealuminated halloysite is not limited to spray drying and may include any suitable bulk powder drying process.

In some instances, the halloysite may contain small amounts of iron oxide that may be removed through an aqueous leaching process. According to some embodiments, iron oxide that remains after the metallothermic reduction may be facilely removed due to the drastic changes in the halloysite's chemistry.

In the present embodiments, the metal reducing agent includes magnesium (Mg), aluminum (Al), or a combination thereof. The metal reducing agent may additionally or alternatively include zinc (Zn), lithium (Li), sodium (Na), potassium (K), other suitable metals, or combinations thereof. For purposes of illustration, the present discussion of the metallothermic reaction utilizes Mg as the metal reducing agent. In the present embodiments, the metal reducing agent is utilized in a powdered form.

In some embodiments, the metal reducing agent, such as Mg, may be provided as Mg vapor in the gas phase from more cost-effective forms of Mg metal (ingots). The benefits of this may include an increase in the capacity of the furnace 100 as only the silica precursor is provided in the solid phase. Advantageously, reacting the metal reducing agent in the vapor phase may be beneficial for maintaining the silica precursor's morphology during the reduction reaction, which may also help preserve the nanostructures of the resulting silicon product. In some embodiments, the metal reactant is provided as a powder. For example, Mg can be provided as a powder having a particle size ranging from about 300 mesh (e.g., about 50 μm) to about 6 mesh (e.g., about 3 mm).

If the particle size of the metal reducing agent (e.g., Mg) is too large (e.g., larger than about 3 mm or 6 mesh), then the metal reducing agent may have a lower surface-area-to-volume ratio. In one example, during a reduction reaction that utilizes Mg as the metal reducing agent, a Mg-containing gas is produced from the Mg powders' surface and subsequently reacts with the silica precursor. Therefore, larger Mg particles may lead to slower reduction reaction and, accordingly, a longer reaction time is needed. For example, a reduction reaction utilizing Mg particles with a size greater than about 6 mesh in size (e.g., about 3-mm) may take about six to eight hours to complete without adjusting other parameters, such as pressure. In contrast, Mg particles with a 300 mesh size (or less) may lead to a 15-minute reaction time, thereby significantly improving the throughput of the production of porous silicon particles.

In some embodiments, by controlling one or more of the parameters provided herein, the metal reducing agent can also be provided in particle sizes larger than 6 mesh. In some embodiments, one or more parameters of the metallothermic reduction process, such as reaction time, application of the thermal moderator, reaction temperature, and reaction pressure, can be adjusted (or tailored) according to a given particle size (or range of sizes) of one or more of the metal reducing agent and the thermal moderator, thereby allowing the production process to be more economic and versatile. For example, applying negative pressure in the tube 106 may increase the rate of vaporization for larger Mg particles, thereby improving the reaction time compared to instances when no negative pressure was applied. On the other hand, when smaller Mg particles of a 300 mesh size (or less) are used, the reaction time can be reduced to about 15 min without applying any pressure in the tube 106.

In some examples, the thermal moderator (e.g., salt), may have a particle size ranging from about 325 mesh (e.g., about 44 um) to about 80 mesh (e.g., about 177 um). In some examples, the particle size of the thermal moderator may be less than about 325 mesh. Other particle sizes may also be suitable for the implementation of the multistep reaction.

In some embodiments, the mixture (e.g., the first mixture, the second mixture, etc.) containing the silica precursor, the metal reducing agent, and the thermal moderator, if applicable, are all provided in powdered form, for example, is first homogenized in a blending process to be thoroughly combined, where sizes of grains of the salt (e.g., the thermal moderator) are also reduced. In one such example, the salt may be ground from a table salt (e.g., NaCl) grade to a much finer size.

At operation 204, the method 200 performs a pre-treatment of the first mixture, which includes the total amount (i.e., the first amount) of the silica precursor, the total amount (i.e., the second amount) of the thermal moderator, and a first fraction of the total amount (i.e., the third amount) of the metal reducing agent.

In some embodiments, the pre-treatment includes continuously rotating the tube 106 to agitate the first mixture. In the present embodiments, the continuous rotation of the tube 106 is implemented by the mixing module 130. In some embodiments, the pre-treatment includes adjusting the gas environment in the interior cavity of the tube 106. In some embodiments, adjusting the gas environment includes applying a negative pressure to the tube 106, a process implemented by the vacuum module 170. In some embodiments, adjusting the gas environment includes filling the interior cavity of the tube 106 with an inert gas, such as Ar or N2, at a pressure similar to the atmospheric pressure, which is at about 1 atm.

In some embodiments, the gas environment in the interior cavity of the tube 106 is established by first flowing an inert gas through the tube 106 for about 30 minutes to replace or purge the ambient atmosphere inside. Such purging may be repeated three times to establish the inert gas environment. Once the inert gas environment is reached, a flow rate of the inert gas applied to maintain the pressure within the tube 106 may be about 175 mL/min, for example.

At operation 206, the method 200 performs a first thermal treatment to the first mixture, thereby completing the first step of the multistep reaction. In the present embodiments, the first thermal treatment is implemented and monitored by the heating module 150.

In some embodiments, performing the first thermal treatment includes first performing a degassing process by heating the first mixture to a temperature that is less than an initiating temperature at which the exothermic (e.g., the metallothermic) reaction occurs according to Equation I (or an analogous reaction using a different metal reducing agent).

Subsequently, performing the first thermal treatment includes heating the (degassed) first mixture to reach a first temperature, which is a temperature that initiates the exothermic reaction occurs. In some embodiments, heating the first mixture to the first temperature provides enough heat for the temperature of the first mixture to spike (e.g., reach a maximum). In some embodiments, the first temperature may be in a range of about 450° C. to about 600° C., such as in a range of about 490° C. to about 530° C.

In some embodiments, the first mixture is heated to the first temperature at a rate of about 1° C./min, although other heating rates may also be applicable. The resulting treated first mixture includes the reaction products and any remaining, unreacted silica precursor, as well as the total amount (i.e., the second amount) of the thermal moderator.

After heating the first mixture to the first temperature, performing the first thermal treatment further includes cooling the treated first mixture by cooling the furnace 100 to a temperature between room temperature and about 300° C., for example, thereby completing the first step of the multistep reaction. In various embodiments, the cooling of the treated first mixture is implemented by placing the treated first mixture in an indirect cooling zone in the tube 106.

At operation 208, the method 200 provides the second fraction (e.g., second portion, second part, etc.) of the third amount of the metal reducing agent to the now-treated (e.g., reacted) first mixture to form the second mixture. As described herein, the treated first mixture includes any unreacted silica precursor, which is less than the first amount in quantity, all (or substantially all) of the thermal moderator, and reaction products that include silicon particles (e.g., porous silicon particles) and MgO. The treated first mixture is free, or substantially free, of any metal reducing agent, which has been consumed during the first thermal treatment at operation 206, and an amount of the reaction products corresponds to the first fraction of the metal reducing agent included in the first mixture before performing the first thermal treatment. As described above, for embodiments in which the multistep reaction includes two steps, the sum of the first fraction and the second fraction is about 1.

At operation 210, the method 200 performs a second thermal treatment to the second mixture, thereby completing the second step of the multistep reaction. In the present embodiments, the second thermal treatment is implemented and monitored by the heating module 150.

For embodiments in which the multistep reaction includes only two steps, i.e., the second step is the final step of the multistep reaction, performing the second thermal treatment includes heating the second mixture to a second temperature that is greater than or equal to the first temperature. In some embodiments, the second temperature is in a range of about 500° C. to about 800° C., such as in a range of about 530° C. to about 760° C. In some examples, the second temperature may be in a range of about 700° C. to about 760° C. or about 740° C. to about 760° C. The second temperature is sufficiently high to convert all, or substantially all, of the silica precursor to silicon (e.g., porous silicon particles) according to Equation I, for example. In some embodiments, operating within the example range of about 500° C. to about 800° C. allows for fine-tuning of the reaction speed. For instance, where the second temperature is a lower temperature (e.g., closer to about 500° C., about 530° C., about 650° C.) might be used for a slower, more deliberate reaction, potentially influencing physical properties, such as morphology and/or purity, of the silicon nanoparticles. Conversely, where the second temperature is a higher temperature (e.g., about 760° C., about 800° C.) can accelerate the reaction without the risks of a runaway process, thanks to the inherent stability provided by the initial controlled stage and the lack of intermediate Mg addition. This temperature range enables precise control over the reaction speed and facilitates the creation of variations in the final silicon product, allowing for tailored properties such as purity and form for specific applications.

In some embodiments, the second mixture is held at the second temperature for a period of time, ranging from about 30 minutes to about 6 hours, for example, to allow the reaction to proceed to completion (i.e., complete, or substantially complete, conversion of the silica precursor to silicon). The resulting treated second mixture includes the reaction products and any remaining, unreacted silica precursor, as well as the total amount of the thermal moderator. For embodiments in which the multistep reaction is a two-step reaction, the treated second mixture does not include any, or any substantial amount of, unreacted silica precursor.

Alternatively, for embodiments in which the multistep reaction includes more than two steps, i.e., the second step is not the final step of the multistep reaction, performing the second thermal treatment includes heating the second mixture to a third temperature that is about the same as the first temperature.

After heating the second mixture, performing the second thermal treatment further includes cooling the treated second mixture by cooling the furnace 100, for example, thereby completing the second step of the multistep reaction.

At operation 212, the method 200 optionally provides a third fraction (e.g., third portion, third part, etc.) of the third amount of the metal reducing agent to the treated second mixture to form a third mixture. As described above, for embodiments in which the multistep reaction includes three steps, the sum of the first fraction, the second fraction, and the third fraction, is about 1.

At operation 214, the method 200 optionally performs a third thermal treatment to the third mixture, thereby completing the third step of the multistep reaction. Similar to the first thermal treatment and the second thermal treatment, the third thermal treatment is implemented and monitored by the heating module 150.

For embodiments in which the multistep reaction includes only three steps, i.e., the third step is the final step of the multistep reaction, performing the third thermal treatment includes heating the third mixture to a fourth temperature that is greater than the first temperature and the third temperature. In some embodiments, the fourth temperature is in a range of about 500° C. to about 800° C., such as in a range of about 530° C. to about 760° C. as described herein. In some examples, the fourth temperature may be in a range of about 700° C. to about 760° C. or about 740° C. to about 760° C.

In some embodiments, the third mixture is held at the fourth temperature for a period of time, ranging from about 30 minutes to about 6 hours, for example, to allow the reaction to proceed to completion (i.e., complete, or substantially complete, conversion of the silica precursor to silicon). The resulting treated third mixture includes the reaction products and any remaining, unreacted silica precursor, as well as the total amount of the thermal moderator. For embodiments in which the multistep reaction is a three-step reaction, the treated third mixture does not include any, or any substantial amount of, unreacted silica precursor.

Alternatively, for embodiments in which the multistep reaction includes more than three steps, i.e., the third step is not the final step of the multistep reaction, performing the third thermal treatment includes heating the third mixture to a fifth temperature that is about the same as each of the first temperature and the second temperature.

After heating the third mixture, performing the third thermal treatment further includes cooling the treated third mixture by cooling the furnace 100, for example, thereby completing the third step of the multistep reaction. Additional step(s) may be performed after performing the operation 214. Alternatively, the operations 212 and 214 are omitted and the method 200 directly proceeds from the operation 210 to operation 216.

At operation 216, the method 200 collects the reaction products, including the porous silicon particles, from the tube 106 of the furnace 100 to an ambient environment (e.g., exposure in air). In the present embodiments, the collection of the reaction products is implemented by emptying the tube 106 using, for example, the tilting module 160. In the case of continuous process implemented in the furnace 100, the product hopper 110 can be isolated and disconnected via a hand-controlled valve at the material outlet 108.

In some embodiments, the collection of the porous silicon particles (and any accompanying metal oxide and/or metal silicide) is implemented, at least in part, by the tilting of the tube 106 using the tilting module 160.

At operation 218, the method 200 may implement additional operations including, for example, removing primary reaction byproduct(s) and removing or otherwise collecting secondary reaction products or byproducts. In some instances, the removal of the secondary reaction products and byproducts includes one or more effluent (e.g., solution-based) treatments described below.

In some embodiments, the reaction products that include the porous silicon particles are washed (or leached) in an acid bath, such as a hydrochloric acid (HCl) bath, to remove any unreacted silica precursor, secondary product such as MgO (see Equation I), and/or any byproducts, leaving a suspension of solid silicon product (i.e., the porous silicon particles) to be collected. Factors including the concentration (e.g., the molar amount) of the acid, the temperature of the acid, and the residence time of the reacted mixture in in the acid, can be adjusted to control the acid wash process. In some examples, the duration of the acid wash may be adjusted according to the concentration of the acid bath for a given acid used. In some embodiments, the concentration and the duration of the acid wash process are adjusted based on the yield of silicon in the reaction product.

When a large amount of a thermal moderator is used in the production of silicon particles, a large amount of water is needed to remove the thermal moderator from the silicon particles as well as to dilute the acid used to dissolve the MgO. In some instances, this washing process may be repeated to ensure that all, or substantially all, of the thermal moderator is removed and a suitable product (e.g., silicon) purity is achieved. Accordingly, when the amount of the thermal moderator is reduced, the extent of such washing process can also be reduced or eliminated entirety, thereby decreasing the cost and complexity, as well as the consumption of water, of the production of the silicon particles.

Furthermore, the removal of MgO using the acid bath generally produces MgCl₂ and water in a brine solution, which also dissolves any thermal moderator present in the reaction products, rendering the isolation of MgCl₂ (e.g., MgCl₂ effluent) from the thermal moderator a challenging task. However, reducing the amount of the thermal moderator can also reduce the complexity of isolating MgCl₂ from the brine solution and increase the economic value recovered from the secondary products and/or byproducts of the multistep reactions.

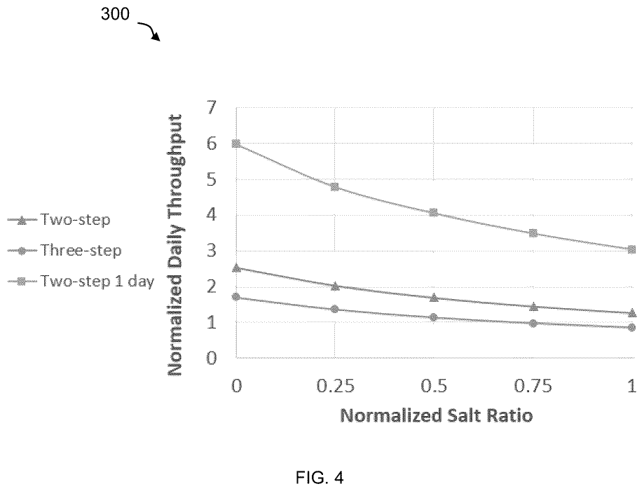

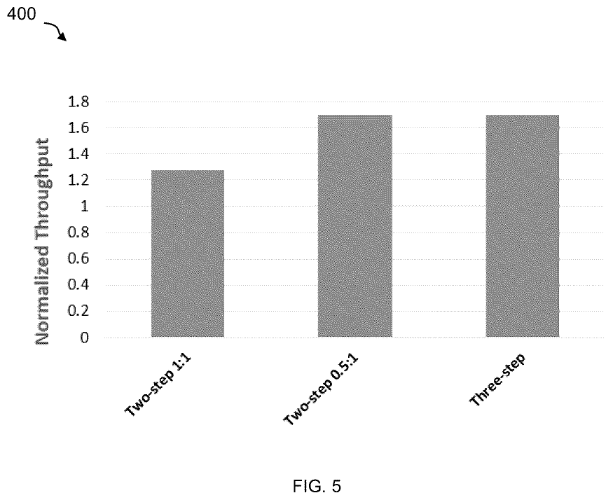

By applying only a fraction of the metal reducing agent at each step of the multistep reaction the amount of the exothermic energy released during the reaction can be reduced, thus requiring a lesser amount of the thermal moderator to absorb any excess exothermic energy. As described above, the benefits of using less thermal moderator include, but are not limited to, increased reaction throughput by increasing the relative amount of the reactants used in the furnace 100, less washing water required for the removal of excess thermal moderator after the reaction is completed, and improved isolation of reaction byproduct (e.g., MgO). Accordingly, the overall economic cost of producing the silicon particles can be lowered and the value generated by such production can be improved. The increase in the reaction throughput due to the implementation of the multistep reactions is discussed in greater detail in reference to FIGS. 4 and 5.

Plot 300 of FIG. 4 depicts a relationship between the reaction throughput (e.g., daily throughput) and the amount of thermal moderator utilized for each of three types of multistep reactions: a two-step reaction implemented over a period of two days (e.g., 48 hours; “two-step”), a three-step reaction implemented over a period of three days (e.g., 72 hours; “three-step”), and a two-step reaction implemented over a period of one day (e.g., 24 hours; “two-step 1 day”). Specifically, values of daily throughput depicted along the Y axis are normalized against a value of daily throughput of a one-step reaction. As such, a normalized daily throughput greater than 1 indicates an improvement in daily throughput over the one-step reaction. Furthermore, values depicted along the X axis are each defined as a ratio (hereafter referred to as the “salt ratio”) of the amount of the thermal moderator (i.e., the second amount) to the sum of the amounts of the reactants (i.e., the sum of the first amount and the third amount) of each multistep reaction normalized against the salt ratio of the one-step reaction, which is about 4:1. In this regard, a normalized salt ratio of 1 corresponds to a salt ratio of 4:1, a normalized salt ratio of 0.5 corresponds to a salt ratio of 2:1, and a normalized salt ratio of 0.25 corresponds to a salt ratio of 1:1.

As depicted in the plot 300, across all the normalized salt ratios, the normalized daily throughput of the two two-step reactions each yield a higher normalized daily throughput than the three-step reaction. Furthermore, the two-step reaction implemented over a period of one day yields a higher normalized daily throughput than the two-step reaction implemented over a period of two days. Still further, the normalized daily throughput gradually decreases as the normalized salt ratio increases, indicating that reducing the amount of thermal moderator has a positive effect on improving the reaction throughput of each of the multistep reactions provided herein.

Plot 400 of FIG. 5 compares three different multistep reactions in terms of their reaction throughput normalized against the throughput of the one-step reaction, which is implemented using a salt ratio of 4:1 as defined above. The “two-step 1:1” reaction refers to a two-step reaction implemented using a normalized salt ratio of 1:1, or 1, the “two-step 0.5:1” reaction refers to a two-step reaction implemented using a normalized salt ratio of 0.5:1, or 0.5, and the “three-step” reaction refers to a three-step reaction implemented using a normalized salt ratio of 0, i.e., no thermal moderator is used when implementing the three-step reaction. The normalized salt ratios depicted in the plot 400 corresponds to the values of the X axis in the plot 300 described above.

The comparison between the three different multistep reactions corroborates the finding that, when a number of steps (e.g., two) is held constant, reducing the amount of the thermal moderator improves the reaction throughput. Furthermore, by increasing the number of steps from two to three, an improvement in reaction throughput can be expected even without utilizing any thermal moderator (i.e., with a normalized salt ratio of 0). A similar extent of improvement in reaction throughput can be expected when a two-step reaction is implemented with a slightly higher normalized salt ratio of 0.5.

In various embodiments, improving the reaction throughput of the multistep reaction can be achieved by increasing the number of steps, reducing the amount of the thermal moderator, or both. For example, as depicted in the plot 300, when the multistep reaction includes only two steps, any normalized salt ratio of less than 1 would yield an improvement in the reaction throughput, i.e., the normalized daily throughput is greater than 1. Decreasing the normalized slat ratio between 0 and 1 can further improve the normalized daily throughput. Furthermore, when the multistep reaction includes three steps, a normalized salt ratio of less than 0.75 would also yield an improvement in the reaction throughput.

The multistep reactions described herein may result in at least the following advantages. Firstly, by reducing an amount of a thermal moderator used in a multistep reaction described herein, a reaction throughput based on a furnace (e.g., the furnace 100) with a defined volume is increased by almost 50%, which can be translated to significant savings on capital expenses. Secondly, reducing the amount of the thermal moderator used can significantly reduce the consumption of energy per unit weight (e.g., ton) of the production of the silicon particles. Thirdly, by reducing the amount of the thermal moderator used in the multistep reactions, purity of the MgCl₂ effluent post-production can be improved significantly, enhancing the ability to recover and subsequently sell back any recovered MgCl₂ rather than discarding it as waste. Fourthly, by reducing the amount of the thermal moderator used in the multistep reactions, the consumption of water can be significantly reduced, lowering the cost of the overall effluent treatment associated with the production of silicon particles described herein.

As utilized herein, the terms “about,” “substantially,” “generally,” “approximately,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the appended claims.

As used herein, the terms “about” and “approximately” generally mean plus or minus 5% of the stated value. For example, about 0.5 would include 0.475 and 0.525, about 10 would include 9.5 to 10.5, about 1000 would include 950 to 1050.

The term “coupled” and the like, as used herein, mean the joining of two components directly or indirectly to one another. Such joining may be stationary (e.g., permanent) or moveable (e.g., removable or releasable). Such joining may be achieved with the two components or the two components and any additional intermediate components being integrally formed as a single unitary body with one another, with the two components, or with the two components and any additional intermediate components being attached to one another.

It is important to note that the construction and arrangement of the various systems shown in the various example implementations is illustrative only and not restrictive in character. All changes and modifications that come within the spirit and/or scope of the described implementations are desired to be protected. It should be understood that some features may not be necessary, and implementations lacking the various features may be contemplated as within the scope of the disclosure, the scope being defined by the claims that follow. When the language “a portion” is used, the item can include a portion and/or the entire item unless specifically stated to the contrary.

Also, the term “or” is used, in the context of a list of elements, in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

Additionally, the use of ranges of values (e.g., W1 to W2, etc.) herein are inclusive of their maximum values and minimum values (e.g., W1 to W2 includes W1 and includes W2, etc.), unless otherwise indicated. Furthermore, a range of values (e.g., W1 to W2, etc.) does not necessarily require the inclusion of intermediate values within the range of values (e.g., W1 to W2 can include only W1 and W2, etc.), unless otherwise indicated.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method of producing silicon particles, comprising:
providing a first mixture to an interior cavity of a rotary tube furnace, the first mixture including a first amount of a silica precursor, a second amount of a thermal moderator, and a first fraction of a third amount of a metal reducing agent;
performing a first thermal treatment to the first mixture;
providing a second fraction of the third amount of the metal reducing agent to the treated first mixture to form a second mixture;
performing a second thermal treatment to the second mixture; and
collecting a reaction product after performing the second thermal treatment, wherein the reaction product includes the silicon particles, and wherein a mass ratio of the second amount to a sum of the first amount and the third amount is less than or equal to 1:1.

2. The method of claim 1, wherein performing the first thermal treatment includes heating the first mixture to a temperature in a range of 490° C. to 530° C.

3. The method of claim 1, wherein a sum of the first fraction and the second fraction is equal to 1.

4. The method of claim 3, wherein performing the second thermal treatment includes heating the second mixture to a temperature in a range of 530° C. to 760° C.

5. The method of claim 1, further comprising:
providing a third fraction of the third amount of the metal reducing agent to the treated second mixture to form a third mixture; and
performing a third thermal treatment to the third mixture, wherein a sum of the first fraction, the second fraction, and the third fraction is equal to 1.

6. The method of claim 5, wherein collecting the reaction product is performed after performing the third thermal treatment.

7. The method of claim 5, wherein:
performing each of the first thermal treatment and the second thermal treatment includes heating the second mixture and the third mixture, respectively, to a temperature in a range of 490° C. to 530° C., and performing the third thermal treatment includes heating the third mixture to a temperature in a range of 530° C. to 760° C.

8. The method of claim 1, wherein the metal reducing agent includes at least one metal selected from the group consisting of magnesium, aluminum, sodium, potassium, zinc, and lithium.

9. The method of claim 1, wherein the thermal moderator includes at least one material selected from the group consisting of sodium chloride and magnesium chloride.

10. A plurality of silicon particles produced by the method of claim 1.

11. The method of claim 1, wherein a mass ratio of the first amount to the third amount is in a range of 1:1 to 1:1.1.

12. A method of producing silicon particles, comprising:
providing a first mixture to an interior cavity of a rotary tube furnace, the first mixture including a silica precursor, a thermal moderator, and a first amount of a metal reducing agent;
performing a first thermal treatment to the first mixture at a first temperature;
providing a second amount of the metal reducing agent to the treated first mixture to form a second mixture;
performing a second thermal treatment to the second mixture at a second temperature that is greater than or equal to the first temperature; and
collecting a reaction product after performing the second thermal treatment, wherein the reaction product includes the silicon particles, and wherein an amount of the thermal moderator is less than or equal to a sum of an amount of the silica precursor, the first amount of the metal reducing agent, and the second amount of the metal reducing agent.

13. The method of claim 12, wherein the first temperature is in a range of 490° C. to 530° C.

14. The method of claim 12, wherein the second temperature is in a range of 530° C. to 760° C.

15. The method of claim 12, wherein the metal reducing agent includes at least one metal selected from the group consisting of magnesium, aluminum, sodium, potassium, zinc, and lithium.

16. The method of claim 12, wherein the thermal moderator includes at least one material selected from the group consisting of sodium chloride and magnesium chloride.

17. The method of claim 12, further comprising:
providing a third amount of the metal reducing agent to the treated second mixture to form a third mixture, and performing a third thermal treatment to the third mixture at a third temperature, wherein the amount of the thermal moderator is less than or equal to a sum of the amount of the silica precursor, the first amount of the metal reducing agent, the second amount of the metal reducing agent, and the third amount of the metal reducing agent.

18. The method of claim 17, wherein collecting the reaction product is performed after performing the third thermal treatment.

19. The method of claim 17, wherein the third temperature is in a range of 530° C. to 760° C.

20. The method of claim 12, wherein a ratio of the amount of the thermal moderator to the sum of the amount of the silica precursor, the first amount of the metal reducing agent, and the second amount of the metal reducing agent is less than 4:5.
